(19) United States
(12) Patent Application Publication
(10) Pub. No.: US 2026/0218943 A1
(43) Pub. Date: Jul. 30, 2026

(54) Clamping Element for Solar Panels

(71) Applicant: Enstall Europe B.V., Deventer (NL)

(72) Inventors: Wim Van 'T Hul, Deventer (NL); Maarten Smit, Deventer (NL)

(21) Appl. No.: 19/150,267

(22) PCT Filed: Jan. 23, 2024
(86) PCT No.: PCT/NL2024/050031

§ 371 Date: Jul. 23, 2025

(30) Foreign Application Priority Data
Jan. 24, 2023 (NL) 2034020

(51) Int. Cl. F24S 25/634; F24S 25/60

(52) U.S. Cl. CPC F24S 25/634; F24S 2025/6003

(57) ABSTRACT

The invention relates to a clamping element configured engaging at least part of an edge of a solar panel and a system including such clamping element and at least one support structure for supporting at least part of at least one solar panel.

### CROSS-REFERENCE TO RELATED APPLICATIONS

This application is the United States national phase of International Patent Application No. PCT/NL2024/050031 filed Jan. 23, 2024, and claims priority to The Netherlands Patent Application No. 2034020 filed Jan. 24, 2023, the disclosures of which are hereby incorporated by reference in their entireties.

### BACKGROUND OF THE INVENTION

### Field of the Invention

The invention relates to a clamping element and a system comprising such clamping element. The invention also relates to an assembly of a system according to the present invention and at least one solar panel and a method for mounting at least one solar panel on a substantially flat mounting surface via using a clamping element and/or system according to the present invention.

### Description of Related Art

Solar panels see application on both pitched mounting surfaces such as pitched roofs, and substantially flat mounting surfaces including flat roofs or (slightly) inclined roofs, as well as flat or slightly inclined (ground) surfaces. Legislation often prescribes a size limitation for solar panels installed on pitched roofs for the purpose of installation safety. However, such limitations commonly do not apply for the installation of solar panels on flat mounting surfaces. In the latter case, solar panels can thus be given relatively large dimensions, effectively increasing the surface area occupied by the solar cells and thus the energy generating capacity of the solar panels. Nowadays, it is even more focused on relatively large surface areas to be covered by solar panel due to an increased interest in renewable energy sources. This requires a relatively large solar panel mounting structure or mounting system which is configured to be set up in a time- and labour efficient manner.

### SUMMARY OF THE INVENTION

Hence, it is an object of the invention to provide an improved system and/or components thereof and method for mounting at least one solar panel on a substantially flat mounting surface, or at least to provide an alternative to the known systems, components and/or methods.

The invention provides thereto a clamping element which is in particular configured engaging at least part of an edge of a solar panel, comprising optionally at least one, and preferably at least two guiding members configured to guide over or with respect to a rail of a solar panel system, optionally at least one inclined upper surface configured for engaging at least part of a solar panel and optionally at least one receiving space for receiving at least part of an edge of a solar panel.

The clamping element according to the present invention enables mounting of at least one solar panel in a relatively fast and simple manner. The clamping element enables that that a solar panel can be (clampingly) mounted or secured within a solar panel system whereby the use of mechanical fixing means, such as screws, can be omitted. The clamping element is an improved version of the known clamping elements. The clamping element is in particular configured for clamping and/or fixating at least part of a solar panel, in particular within a solar panel mounting system.

The clamping element according to the present invention can also be referred to as base element, zipper and/or module locker. The clamping element is in particular configured to slide over a rail of a solar panel system. It is also conceivable that the clamping element is positioned at least partially inside of a rail of a solar panel system. The clamping element is in particular configured to slide over a rail of a solar panel system.

Preferably, the clamping element comprises at least one inclined upper surface configured for engaging at least part of the solar panel. The inclined upper surface may provide support for the solar panel once the solar panel is mounted within the system. Part of the solar panel may directly engage upon the inclined upper surface. Preferably the angle of inclination is in line with the inclination of the mounted solar panel. The inclined upper surface may also act as a guiding surface configured for enabling easier installation of the solar panel within the system.

Preferably, at least part of at least one receiving space is substantially V-shaped. The module frame of a solar panel can be secured by pulling the frame flanges into a V-shaped opening, which is preferably present on both sides of the clamping element. This V-shaped opening accommodates for different flanges thicknesses. Preferably, at least one V-shaped receiving space comprises at least one inwardly extending bulge. It is for example conceivable that at least one V-shaped receiving space is defined by one straight leg and one leg with an inward protruding bulge.

At least one inwardly protruding or extending bulge is in particular configured to prevent excessive flexing of at least part of a solar panel, in particular a frame flange thereof under an uplift load. It is also imaginable that the clamping element comprises at least one receiving structure, wherein at least one receiving structure defines at least one receiving space. It can also be said that at least one receiving structure comprises at least one receiving space. At least part of at least one receiving structure is preferably substantially V-shaped. It is for example conceivable that at least one V-shape defined by the receiving structure comprises at least one inward protruding bulge. The V-shaped part of the receiving structure and/or receiving space may be defined by a substantially straight leg and a leg with an inward protruding bulge that meet to form the V-shape. The receiving structure may comprise a surface that extends across the two guiding members proximate the substantially straight leg of the V-shaped part.

It is possible that at least one receiving space and/or receiving structure comprises or is defined by at least one retaining surface configured to engage at least part of the second edge of the solar panel. At least one retaining surface can be located inside at least one V-shaped receiving space. It is also imaginable that at least one leg which defines the receiving space comprises a retaining surface. When it is referred to a bulge, within the context of the present invention, also an irregularity, knob, lump, obstacle, bump, knot, curve or the like can be meant. The bulge in particular creates an interruption of a linear line or leg defining the V-shape. When it is referred to a V-shape, it is meant that two legs are present which engage under an edge, in particular an edge smaller than 90 degrees, preferably smaller than 45 degrees, more preferably smaller than 35 degrees, 30 degrees, 25 degrees or 15 degrees.

Preferably, the clamping element comprises at least two receiving spaces, wherein at least two receiving spaces are positioned at a predetermined distance of each other. It is for example possible that at least two receiving spaces are located at opposing sides of the clamping element. Preferably, each receiving space is configured for receiving at least part of an edge of a solar panel.

The clamping element preferably comprises at least one guiding member configured to guide the clamping element over a rail or with respect to a rail of a solar panel system. The at least one guiding member is preferably configured to enclose a rail. It is also conceivable that the clamping element comprises at least two opposing guiding members configured to guide the clamping element with respect to a rail of a solar panel system.

In a preferred embodiment is at least part of the clamping element made of a conductive material, in particular metal. It is also conceivable that at least part of the clamping element comprises a conductive material, in particular metal. The clamping element can also be fully made of metal. It is also conceivable that the clamping element is at least partially made of plastic, and/or a lightweight composite such as a fibre-reinforced plastic, and/or a metal, preferably a lightweight metal such as aluminium. In case a resilient lip and/or a retention element is applied, the resilient lip and/or the retention element is preferably made in one piece with the clamping element. In a further preferred embodiment, the clamping element comprises steel or is substantially made of steel. The clamping element being made of steel can benefit from a good durability as well as a good resistance to environmental influences, resulting in a relatively long lifetime. In yet another preferred embodiment, at least part of the clamping element comprises steel, in particular steel which is at least partially coated with a zinc-aluminium-magnesium alloy. The same non-limiting examples of materials to be applied applies for the bracket, if applied.

The clamping element preferably comprises at least one protruding cutting member configured for penetrating a surface of at least part of a solar panel, in particular a frame of solar panel. At least one penetrating member can be configured for the provision of surface scratch in particular to a solar panel or a part thereof. The cutting member may also enable bonding. It is for example imaginable that the clamping element comprises a cutting member which is present on part of at least one V-shaped receiving space such that the cutting member can come into contact with part of a solar panel or frame thereof received in the receiving space. The clamping element may also comprise at least one profiled contact area in particular configured for providing a restraining effect and/or for providing bonding.

The clamping element could also comprise at least one edge or rim and/or at least one flange. The clamping element may also comprise at least one gripping element configured for manual gripping. The presence of at least one gripping element may further contribute to the ease of use of the clamping element, and thus for the system as such. Typically, gripping of the gripping element is a toolless act. The gripping element is preferably configured to be manually gripped by a user. The gripping element may for example comprise a recess configured to be gripped by at least one finger of a user. The gripper element is preferably provided on a distal end of the clamping element, preferably on the frontal side, i.e. a part substantially facing away from the solar panel.

Possibly, the clamping element comprises at least one resilient lip configured for engaging of at least part of the solar panel in a resilient manner. Such resilient lip may, for example, be configured to clampingly engage at least part of a frame part of the solar panel. The resilient lip is preferably configured for providing a clamping force in substantially downward direction. This may further stabilize the position of the solar panel with respect to at least the clamping element. The (second) resilient lip may also contribute to controlled mounting of the solar panel with respect to the clamping element as such. The resilient lip may in fact also act as a secondary locking member. If both applied, it is conceivable that a second receiving space for receiving at least part of the solar panel is at least partially defined by the second retaining surface and the second resilient lip of clamping element.

The clamping element could comprise at least two opposing fastening members. Such fastening members can for example be configured for co-action with a rail of a solar panel system. In a preferred embodiment, the fastening members are configured for providing an interlocking connection with a rail. A benefit of such interlocking connection is that a relatively reliable and/or secure locking connection can be obtained between the base element and the clamping element. Such interlocking connection can prevent undesired unlocking or decoupling between the base element and the locking element. The clamping element may thereto also comprise at least one locking member.

Possibly, the receiving structure of the clamping element comprising at least one support surface for supporting at least part of a solar panel. Said support surface is in particular configured for engaging and thus direct support of at least part of the solar panel.

The clamping element according to the present invention can also be a dual piece clamping element. The clamping element could thereto comprise at least one bracket. The clamping element can be configured for co-action with the bracket. It is also conceivable that at least part of the bracket is received within the clamping element. The bracket can also be referred to as clamping aid, locking aid and/or (clamping) insert. The combination of the clamping element and the bracket could also be referred to as clamp, module locker, or locking and/or clamping device. At least one bracket and clamping element can be releasably connected. It is also conceivable that the clamping element and the bracket are mutually displaceable between at least an initial position and a locked position. In the initial position, the bracket and clamping element are mutually displaceable and in the locked position the bracket and clamping element are mutually locked.

Preferably, at least one bracket comprises at least one locking member. Such locking member is in particular configured for mutual locking of the clamping element and the bracket. At least one bracket may comprise at least one resilient lip. Preferably, at least one bracket comprises at least one cutting member, in particular at least one protruding cutting member. Such cutting member can also be referred to as a claw. Preferably, the bracket comprises multiple cutting members and/or a cutting structure. At least one cutting member can be configured for bonding with the clamping element and/or at least part of at least one solar panel.

At least one bracket may further comprise at least one engagement surface and/or at least reinforcement rib. The clamping element could also comprise at least one reinforcement rib and/or reinforcement structure.

The invention also relates to a system comprising at least one clamping element according to the present invention and at least one support structure for supporting at least part of at least one solar panel. The support structure can also be referred to as base or high base. At least one support structure is in particular configured for supporting at least part of at least one solar panel. The support structure can be connected or connectable to a rail or base element of a solar panel. During mounting of the solar panel within a system according to the present invention, the distance between the clamping element and the support structure is typically increased.

It is conceivable that the support structure comprises at least one retaining element for retaining at least part of a first edge of the solar panel. At least part of at least one retaining element is preferably substantially V-shaped. It is also conceivable that at least part of part of the retaining element defines a V-shape. The module frame of a solar panel can be secured by pulling the frame flanges into the V-shaped retaining element of the support structure. This V-shape accommodates different flanges thicknesses. Preferably, at least one V-shaped part of at least one retaining element comprises at least one inwardly extending bulge. At least one inwardly extending bulge is in particular configured to prevent excessive flexing of at least part of a solar panel, in particular a frame thereof under lift load. At least one retaining element may comprise at least one retaining surface configured to engage at least part of an edge of the solar panel. At least one retaining element could comprise or define a receiving space configured for receiving at least part of an edge of the solar panel. Preferably, at least one retaining element comprises at least one resilient lip configured for engaging of at least part of the solar panel in a resilient manner. The support structure is pivotably connected to at least one base element, such that the support structure and base element are mutually displaceable between at least a collapsed position and an upright position. The support structure could also comprise at least one locking element for locking the support structure and base element at least in the upright position.

Possibly, the retaining element comprises a receiving space configured for receiving at least part of an edge of the solar panel. The receiving space may be configured to enclose at least part of the edge of the solar panel. An embodiment wherein the retaining element comprises a receiving space may provide a more controlled retaining of the solar panel within the mounting system. This may further contribute to the ability to not apply any mechanical fastening means, such as screws, during mounting of the solar panel onto the substantially flat mounting surface. In another preferred embodiment, the retaining element comprises at least one resilient lip configured for (clampingly) engaging of at least part of the solar panel in a resilient manner. Such resilient lip may, for example, be configured to clampingly engage at least part of a frame part of the solar panel. The resilient lip is preferably configured for providing a clamping force in a substantially downward direction and/or a direction towards the support structure. This may further stabilize the position of the solar panel with respect to at least the support structure. The resilient lip may also contribute to controlled mounting of the solar panel with respect to the retaining element as such. The resilient lip may in fact also act as a locking member. If both applied, it is possible that the resilient lip is at least partially received within the receiving space. It is also conceivable that the receiving space is at least partially defined by the retaining surface and the resilient lip, if applied. Possibly, with respect to the abovementioned embodiments, part of the solar panel can be substantially hooked behind part of the retaining element.

It is also possible that the support structure and/or the retaining element comprises a support surface configured for engaging and thus direct support of at least part of the solar panel. In a preferred embodiment of the system, the retaining element is provided at an upper section of the support structure. Hence, a more space efficient system can be obtained. It may further be prevented that system parts and/or system elements extend with respect to the solar panels being mounted within the system. This is beneficial from aesthetic point of view, but also for safety reasons. Further, it is possible that the retaining element is connectable to the support structure and/or that the retaining element is connected to the support structure. In such embodiment, the retaining element could be a separate component configured for co-action with the support structure. By making use of a retaining element it is enabled that different types of retaining element can be used, which could for example be further adapted to the type of solar panel to be mounted. However, it is also possible that the retaining element forms integral part of the support structure. This embodiment may be more rigid and/or may prevent that undesired disconnection between the support structure and the retaining element.

In a further preferred embodiment, the support structure comprises at least two of the retaining elements positioned at a distance from each other, wherein each retaining element is configured for retaining at least part of a flange edge of a solar panel. Typically, the retaining elements are positioned at opposing sides of the support structure. Hence, a first and a second solar panel mounted to respectively a first and a second retaining element, extend in a direction facing away from another. Each of the retaining element could be designed as one of the above mentioned non-limiting examples and or equivalent to the examples described for the clamping element. It is also conceivable that the at least two retaining elements are substantially identical. This may result in the support structure being substantially symmetrical over a cross section in longitudinal direction. As a result thereof, the support structure may provide a balanced situation for the solar panels during use.

In the following non-limiting example, the installation of a solar panel by making use of possible embodiment of the system and clamping element according to the invention is described. A solar panel is laid down on the high base formed by a support structure and pulled with its flange in the V-shape retaining element of the support structure. When the top part is seated correctly the user can slide the clamping element along the rail in a direction away from the support structure until the flange of the solar panel is seated correctly in the V-shape. The user will feel this as a hard end stop. The user could then squeeze the handle formed by part of the bracket and the clamping element together until an audible snap ensures that the module is secured in the clamping element. A resilient lip of the bracket comes up as a visual indicator to check if the clamping element is correctly installed. The module frame is held in place by the two outward directed V-shapes of the support structure and the clamping element and is unable to slide back due to its ratchet mechanism. This locks the module in securely. The V-shape geometry is sized and shaped in such a way that it can accommodate just about all available solar modules. Bonding is preferably done by a sharp metal edge that scratches the anodization on the bottom part of the module frame flange. Also optional locking spikes provide additional bonding scratches. The preferred ‘bump’ in the V-shape of the clamping element and/or the support structure is to limit excessive flexing of the frame during lift load.

The invention also relates to an assembly of a system according to the present invention and at least one solar panel.

The invention also relates to a method for mounting at least one solar panel on a substantially flat mounting surface via using a clamping element and/or system according to the present invention, the method comprising the steps of:
a) providing a system for mounting at least one solar panel on a substantially flat mounting surface preferably according to the present invention;
b) positioning at least one solar panel onto at least one support structure, such that at least part of a first edge of the solar panel is retained by at least one retaining element,
c) engaging at least part of a second edge of the solar panel by displacing at least one clamping element with respect to a base element or rail, and
d) fixating the mutual position of the base element and the clamping element such that the solar panel is clampingly secured within the system.

The method benefits from the same advantages as outlined for the system and clamping element according to the present invention, in particular that toolless mounting of solar panel(s) can be done in a relatively simple and fast manner. It is conceivable that the step of engaging at least part of a second edge of the solar by displacing at least one clamping element with respect to the base element is done performed by sliding the clamping element over the base element in a direction facing away from the solar panel. Typically, during this step, the distance between the clamping surface and the retaining element is increased.

### BRIEF DESCRIPTION OF THE DRAWINGS

The terms Fig., Figs., Figure, and Figures are used interchangeably in the specification to refer to the corresponding figures in the drawings.

The invention will be further elucidated by means of non-limiting exemplary embodiments illustrated in the following figures. Within these figures, similar reference numbers correspond to similar or equivalent elements or features.

FIG. 1 shows a first non-limiting embodiment of a clamping element 101 according to the present invention;

FIGS. 2a-2c shows a second non-limiting embodiment of a clamping element 201 according to the present invention;

FIG. 3 shows a schematic representation of a system 10 according to the present invention;

FIG. 4 shows a detailed view of a receiving structure 205 and receiving space 204 of a clamping element according to the present invention;

FIGS. 5a and 5b show a schematic representation of the installation of a solar panel 30 in a system 10 according to the present invention; and

FIGS. 6a-6c show the clamping element 201 as shown in the previous figures in a pre-assembled position (FIG. 6a) and a locked position (FIGS. 6b and 6c).

### DESCRIPTION OF THE INVENTION

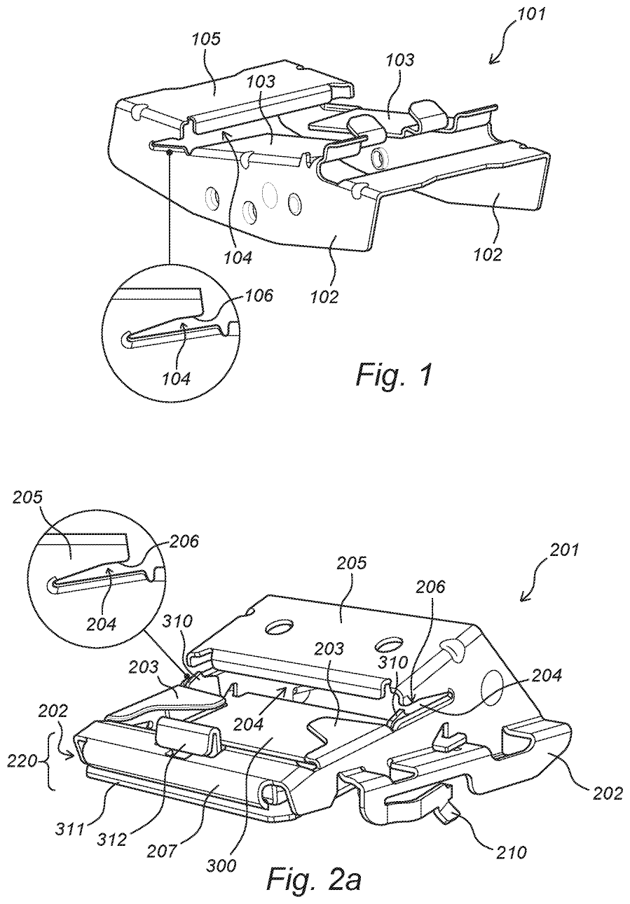

FIG. 1 shows a first non-limiting embodiment of a clamping element 101 according to the present invention. The clamping element 101 is configured to engage at least part of a flange edge of a solar panel (not shown) and comprises two guiding members 102 configured to guide over or guide the clamping element 101 with respect to a rail of a solar panel system, at least one inclined upper surface 103 configured for engaging at least part of a solar panel and a receiving space 104 for receiving at least part of an edge of a solar panel. The clamping element 101 in particular comprises a receiving structure 105. In the shown embodiment, the receiving structure 105 defines a receiving space 104. Part of the receiving structure 105 is substantially V-shaped. In particular, the receiving structures 105 comprises two substantially V-shaped parts defining a V-shaped receiving space 104. Each V-shaped receiving space comprises at least one inwardly extending bulge 106. The V-shaped part of the receiving structure 105 is defined by a substantially straight leg and a leg with an inward protruding bulge 106 that meet to form the V-shape. The receiving structure 105 also includes a surface that extends across the two guiding members 102 proximate the substantially straight leg of the V-shaped part.

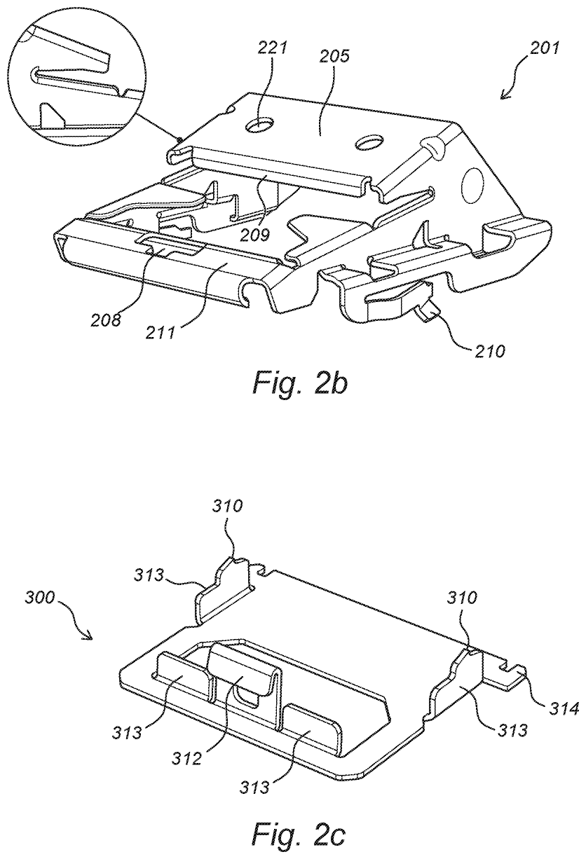

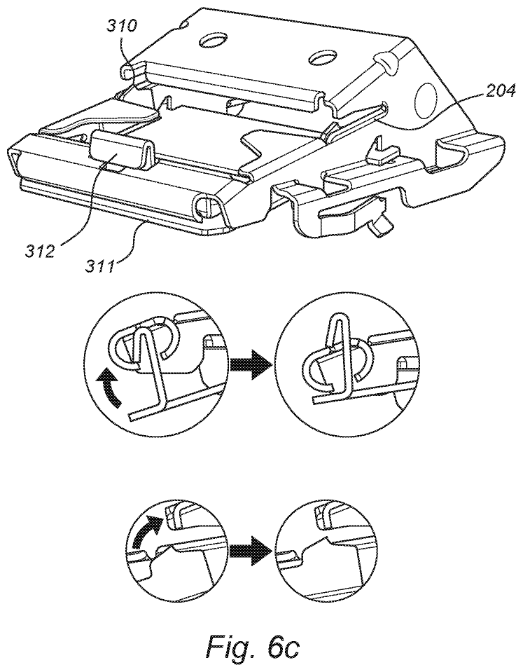

FIGS. 2a-2c shows a second non-limiting embodiment of a clamping element 201 according to the present invention. The clamping element 201 is configured for engaging at least part of an edge of a solar panel (not shown) and comprises two guiding members 202 configured to guide over or guide the clamping element 201 with respect to a rail of a solar panel system, at least one inclined upper surface 203 configured for engaging at least part of a solar panel and a receiving space 204 for receiving at least part of an edge of a solar panel. The clamping element 201 in particular comprises a receiving structure 205 which defines V-shaped receiving spaces 204. The defined V-shaped receiving structure 205 and/or receiving spaces 204 comprise an inwardly extending bulge 206. The V-shaped receiving structure 205 and/or the receiving spaces 204 are defined by a substantially straight leg and a leg with an inward protruding bulge 206 that meet to form the V-shape. The V-shaped receiving structure 205 also includes a surface that extends across the two guiding members 202 proximate the straight leg of the V-shaped part. The clamping element 201 is in particular a two-piece clamping element. The clamping element 201 further comprises a bracket 300. FIG. 2a shows the combination of the clamping element 201 and the bracket 300. FIG. 2b shows the clamping element without the bracket 300. And FIG. 2c shows the bracket 300 as such. The bracket 300 is at least partially received within the clamping element 201 in an area at least partially located under the at least one inclined upper surface 203. The bracket 300 comprises at least one protruding cutting member 310. The cutting member(s) 310 can be configured to cut into at least part of a solar panel (not shown) for the purpose of penetrating a surface treatment such as anodization or other surface coating in order to electrically bond the solar panel to the support structure, as well as to provide a physical resistance to the panel withdrawing from the V-shaped receiving space performing the function of locking the panel frame flange within the V-shape. At least one cutting member 310 could also be referred to as a claw 310. The bracket 300 further comprises a resilient lip 312 and a flange 311. The resilient lip 312 can provide a locking action between the bracket 300 and the clamping element 201. The resilient lip 312 can also be referred to as locking member 312. The combination of the flange 311 and a rim 207 of the clamping element 201 forms a handle 220 which can be manually operated. The resilient lip 312 is received in an accommodation space 208 of the clamping element 201. The accommodation space 208 is defined within a surface 211 that extends between the two guiding members 202 and is located proximate an end of the clamping element 201 opposes the receiving structure 205. The receiving structure 205 comprising a further support surface 209 for supporting at least part of a solar panel. The clamping element 201 may optionally comprise a plurality of through hole, which may be configured to ensure reliable and accurate production of the clamping element 201. The clamping element 201 further comprises locking members 210 for locking the clamping element 201 for example with respect to a rail of a solar panel system. The bracket 300 comprises further engagement surfaces 313 for engaging at least part of the clamping element 201 and at least one retaining leg 314 configured to add strength to the clamping element 201. These retaining surfaces 313 may be beneficial for guiding the bracket 300 into the clamping element 201 during the engagement of the bracket 30 with the clamping element 201, as shown in FIG. 6a.

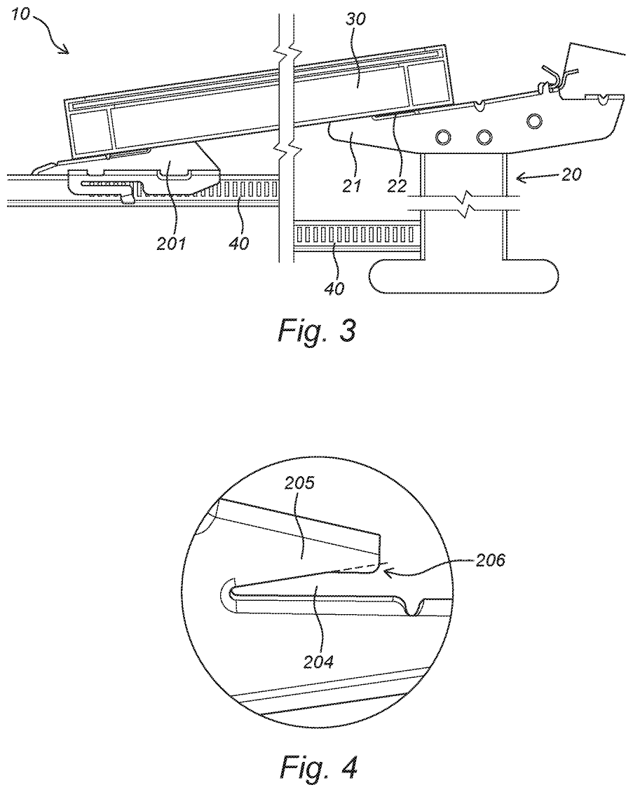

FIG. 3 shows a schematic representation of a system 10 according to the present invention. The system 10 comprises a clamping element 201 according to the present invention. In the shown embodiment, the clamping element 201 is similar to the clamping element 201 as shown in FIG. 2. The system further comprises at least one support structure 20. The support structure 20 is configured for supporting at least part of a solar panel 30. The support structure 20 is connected or connectable to a base element 40, such as a rail 40. The support structure 20 comprises at least one retaining element 21 for retaining at least part of a first edge of the solar panel 30. In the shown embodiment, the retaining element 21 defined at least one V-shaped receiving space 22. The retaining element 21 further comprises at least one retaining surface configured to engage at least part of an edge of the solar panel.

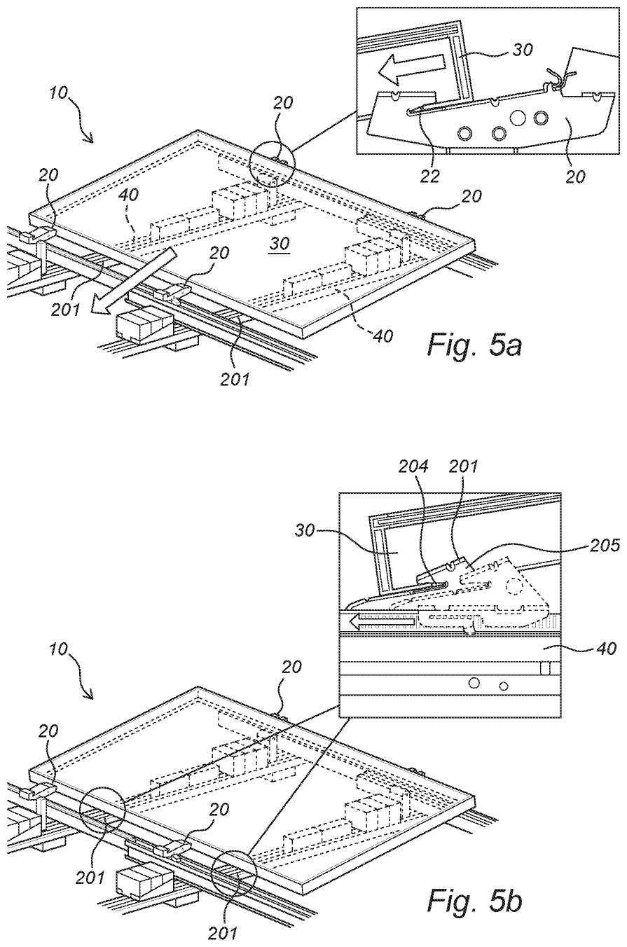

FIG. 4 shows a detailed view of a receiving structure 205 and receiving space 204 of a clamping element according to the present invention. The figure shows the presence of a bulge 206 defined by the receiving structure 205, which is configured to prevent excessive flexing of at least part of a solar panel, in particular a frame thereof under lift load. The lower edge of the V-shaped receiving space 204 is bent or rolled or otherwise deformed such that the sharp corner of the material edge contacts the bottom of the panel frame flange providing a cutting edge configured to penetrate a surface or a surface coating such as anodization or paint or natural oxidation and thereby create an electrical bond between the solar panel frame and the supporting structure.

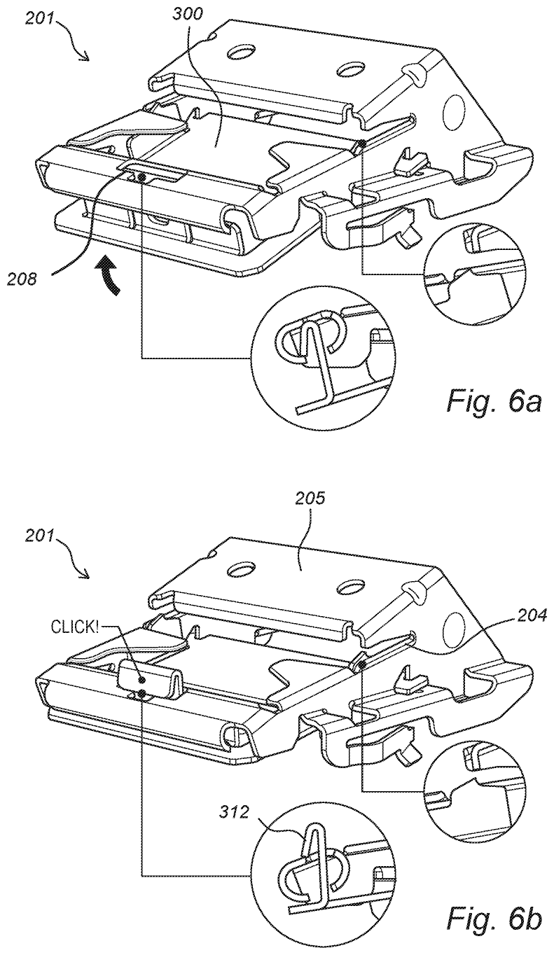

FIGS. 5a and 5b show a schematic representation of the installation of a solar panel 30 in a system 10 according to the present invention. The solar panel 30 is laid down on the support structure 20 and pulled within in the V-shaped receiving space 22 of the support structure 20. When the top part of the solar panel 30 is seated correctly a user can slide the clamping element 201 along the rail 40 to the left directionally away from the support structure 20 until part of the solar panel 30, such as the flange, is seated correctly in the V-shaped receiving space 204. The user can then lock the clamping element 201 into position.

FIGS. 6a-6c show the clamping element 201 as shown in the previous figures in a pre-assembled position (FIG. 6a) and a locked position (FIGS. 6b and 6c). The figures show the activation of the bracket 300 and its resilient lip 312. The resilient lip 312 can be referred to as a locking member 312.

In the figures as shown in 6a-6c, the resilient lip 312 is inserted into the accommodation space 208, as shown in FIGS. 6b and 6c. Upon movement of the resilient lip 312 into the accommodation space 208, the resilient lip 312 temporarily deforms such that the bracket 300 clicks into the clamping element 201. After the click shown in FIG. 6b, the bracket 300 and the clamping element 201 are locked. This movement of the bracket 300 changes the position of the cutting member(s) 310 relative to the clamping element 201. As the resilient lip 312 is moved into the accommodation space 208, the cutting members(s) 310 moved to oppose the V-shaped receiving spaces 204, as shown in FIGS. 6b and 6c. This allows the cutting members(s) 310 to cut into the solar panel that is engaged with the V-shaped receiving spaces 204.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A clamping element configured for engaging at least part of an edge of a solar panel, comprising:
at least two guiding members configured to guide over or with respect to a rail of a solar panel system;
at least one inclined upper surface configured for engaging at least part of a solar panel; and
and at least one receiving space for receiving at least part of an edge of a solar panel, wherein at least part of the at least one receiving space is V-shaped and wherein the at least one V-shaped receiving space comprises at least one inwardly extending bulge.

2. (canceled)

3. (canceled)

4. The clamping element according to claim 1, wherein the clamping element comprises at least one receiving structure, wherein at least one receiving structure defines at least one receiving space.

5. (canceled)

6. (canceled)

7. The clamping element according to claim 1, comprising at least two receiving spaces, wherein at least two receiving spaces are positioned at a predetermined distance of each other.

8. The clamping element according to claim 1, comprising at least two opposing guiding members configured to guide the clamping element with respect to a rail of a solar panel system.

9. The clamping element according to claim 1, wherein at least part of the clamping element is made of a conductive material, in particular metal, and further comprising at least one protruding cutting member configured for cutting into at least part of a solar panel, in particular a frame of solar panel.

10. (canceled)

11. The clamping element according to claim 1, comprising at least one profiled contact area in particular configured for providing a restraining effect and/or for providing bonding.

12. The clamping element according to claim 1, comprising at least one rim and/or at least one flange.

13. The clamping element according to claim 1, wherein the clamping element comprises at least one gripping element configured for manual gripping, and/or comprising at least one resilient lip in particular configured for engaging of at least part of the solar panel in a resilient manner.

14. (canceled)

15. The element according to any of claim 1, comprising at least two opposing fastening members and/or comprising at least one locking member.

16. (canceled)

17. The clamping amping element according to claim 1, wherein the receiving structure comprising at least one support surface for supporting at least part of a solar panel.

18. The clamping element according to claim 1, comprising at least one bracket.

19. The clamping element according to claim 18, wherein at least one bracket comprises at least one locking member, and/or wherein at least one bracket comprises at least one resilient lip.

20. (canceled)

21. The clamping element according to claim 18, wherein at least one bracket comprises at least one cutting member, in particular at least one protruding cutting member.

22. The clamping element according to claim 18, wherein at least one bracket comprises at least one engagement surface.

23. (canceled)

24. A system comprising at least one clamping element according to claim 1 and at least one support structure for supporting at least part of at least one solar panel, wherein the support structure comprises at least one retaining element for retaining at least part of a first edge of the solar panel, wherein at least one V-shaped part of at least one retaining element comprises at least one inwardly extending bulge.

25-27. (canceled)

28. The system according to claim 24, wherein at least one retaining element comprises at least one retaining surface configured to engage at least part of an edge of the solar panel, and/or wherein at least one retaining element comprises a receiving space configured for receiving at least part of an edge of the solar panel.

29. (canceled)

30. The system according to claim 24, wherein at least one retaining element comprises at least one resilient lip configured for engaging of at least part of the solar panel in a resilient manner.

31. The system according to claim 24, wherein the support structure comprises at least two the retaining elements positioned at a distance from another, wherein each retaining element is configured for retaining at least part of an edge of a solar panel.

32. The system according to claim 24, wherein at least one support structure is pivotably connected to at least one base element, such that the support structure and base element are mutually displaceable between at least a collapsed position and an upright position.

33. (canceled)

34. (canceled)

35. A method for mounting at least one solar panel on a substantially flat mounting surface via using a clamping element and/or system according to claim 1, the method comprising the steps of:
a) providing a system for mounting at least one solar panel on a substantially flat mounting surface,
b) positioning at least one solar panel onto at least one support structure, such that at least part of a first edge of the solar panel is retained by at least one retaining element,
c) engaging at least part of a second edge of the solar by displacing at least one clamping element with respect to the base element, and
d) fixating the mutual position of the base element and the clamping element such that the solar panel is clampingly secured within the system.
